(19) United States
(12) Patent Application Publication
(10) Pub. No.: US 2016/0017178 A1
(43) Pub. Date: Jan. 21, 2016

(54) Cellulose-Containing Paint Systems

(71) Applicant: CLARIANT INTERNATIONAL LTD, Muttenz (CH)

(72) Inventors: Tobias NIEDERLEITNER, Feigenhofen (DE); Timo HERRLICH, Buehl (DE); Manuel BROEHMER, Olching (DE); Stefanie GOERES, Worms (DE)

(73) Assignee: CLARIANT INTERNATIONAL LTD., Muttenz (CH)

(21) Appl. No.: 14/773,231

(22) PCT Filed: Mar. 5, 2014
(86) PCT No.: PCT/EP2014/000557

§ 371 Date: Sep. 4, 2015

(30) Foreign Application Priority Data
Mar. 15, 2013 (DE) 10 2013 004 554.1

(51) Int. Cl. C09D 175/06; C09D 101/02; C09D 133/00

(52) U.S. Cl. CPC C09D 175/06; C09D 133/00; C09D 101/02

(57) ABSTRACT

The invention relates to a paint system, containing a) chemically unmodified cellulose and b) optionally polyolefin waxes and/or Fischer-Tropsch waxes and/or amide waxes and/or biologically-based waxes and c) film formers and d) optionally solvents or water and e) optionally pigments and f) optionally volatile and/or nonvolatile additives, wherein the chemically unmodified cellulose has a mean fibre length between 7 [mu]m and 100 [mu]m and a mean aspect ratio of less than 5.

The invention relates to chemically unmodified cellulose-containing paint systems and also to the use of cellulose/wax combinations in paints for improving the settling and redispersing behavior and for significantly improving the scratch resistance and tactility.

### INTRODUCTION

Paints are understood generally according to DIN EN 971-1 to be coating materials having a defined set of properties. As coating materials in liquid, paste or else powder form, paints have the function, according to the standard, of producing visually concealing coatings having decorative properties, protective properties, and also, optionally, specific technical properties. Among mentioned systems, paints may be classified according to the nature of the film former (alkyd resin paint, acrylate resin paint, cellulose nitrate paint, epoxy resin paint, polyurethane resin paint, etc.). Binders are defined, according to the above standard, as the pigment-free and filler-free fractions of the dried and/or cured coating. The binder is therefore composed of a film former and of the nonvolatile fraction of the additives. Undried and/or uncured paint systems are generally composed of a film former such as, for example, an epoxy resin, polyester resin, polyurethane, cellulose derivative, acrylate resin, etc., and optionally of further components such as solvents, additives, fillers, and pigments. Solvent-free systems are customarily used either on an aqueous basis, as dispersion-based paints, for example, or are completely solvent-free, with the film former already being in liquid form (e.g., liquid monomers). Paint systems are further admixed with additives to bring about the desired service properties. Thus, for example, micronized waxes are added in order to endow the painted surfaces with improved scratch resistance, matting, resistance to polishing, and resistance to metal marking (cf., e.g., Fette, Seifen, Anstrichmittel 87, No. 5, pages 214-216 (1985)). A likewise effective protection of the paint surface is achieved through the addition of certain silicones, which, like waxes, lower the coefficient of sliding friction of the dried paint and thereby reduce the phenomenon of blocking and hence improve the scratch resistance (cf. Ullmann's Encyclopedia of Industrial Chemistry, 5^{th} Edition, Vol. A 18, Section 4.3 Paints & Coatings, Weinheim, 1991, page 466). Scratch resistance is important particularly for those paint systems and paint coats that are subject to mechanical stresses, such as in the case, for example, of floors or furniture, such as desks, dining tables, etc., or in the case of various articles of everyday use, such as toys, for example. Particularly in the case of floors, however, in addition to the scratch resistance, an important role is also played by the sureness underfoot and hence by a reduction in the slipping risk—in other words, an increased coefficient of sliding friction. In the case of articles of everyday use and furniture surfaces, a pleasing tactility is frequently desirable. In contrast to sliding friction and scratch resistance, which can be quantified by measurements, the tactility can only be determined qualitatively. As a measure of the touch, terms are used such as, for example, “soft” (soft touch), velvety, smooth, rough, hard, etc. Soft touch/feel effects are obtained in common paint systems by addition of certain waxes or silicones, or directly by means of a very soft polyurethane binder. A soft to velvety touch here is usually in direct contradiction with the required scratch resistance. Particularly in the case of painted wooden surfaces, moreover, an artificial, unnatural tactility often leads to a subjective downgrading by the user. The requirement, instead, is for painted surfaces whose tactility corresponds to that of natural wood.

In the market there is an ongoing need for painted surfaces having a soft and natural feel in conjunction with long-term robustness in use, this being achieved generally by an improvement in the scratch resistance. Both properties together are difficult to combine in a paint system.

The use of cellulose in paints has so far been limited to cellulose derivatives. The reason for this is that cellulose is absolutely insoluble in all customary organic solvents and, in particular, in water. To date, therefore, only cellulose derivatives have been used in paints (cf. BASF Handbook, Lackiertechnik, Vincentz-Verlag, 2002, Section on Raw Materials, page 45). Cellulose nitrate and cellulose esters, in particular, have been much described as adjuvants and also as film formers in paint systems. For instance, cellulose can be modified in different levels of esterification with organic and inorganic acids to form cellulose nitrate and also acetic, propionic, and butyric esters. The esters of cellulose with organic acids differ from cellulose nitrate by virtue in particular of improved light stability and reduced flammability. In addition, cellulose esters are distinguished by heat stability and low-temperature stability that are an improvement on those of cellulose nitrate, but at the expense of poorer compatibility with other resins and organic solvents. To some extent this drawback can be compensated through the use of mixed esters.

Cellulose-based fillers are used customarily in the form of methyl or ethyl ethers for controlling the rheological properties of the liquid paint systems. Only little is known, conversely, about the use of chemically unmodified cellulose in paints. For example, WO 2011/075837 describes nanocrystalline cellulose and silanized nanocrystalline cellulose for paint applications. Nanocrystalline cellulose (NCC) is obtained from purified cellulose, which is obtained by acidic hydrolysis and subsequent dispersion, under ultrasound treatment, for example. The cellulose fibers, disintegrated accordingly into the individual fibrils, have a diameter of 5-70 nm and a length of up to 250 nm. As well as a matting effect and a decrease in the hydrophobic properties of the surface, however, a decrease in the scratch resistance of the polyurethane paint employed has been observed through the use of nanocrystalline cellulose. The effect could only be compensated, or overcompensated, by the use of silanized and hence chemically modified nanocrystalline cellulose.

WO 2010/043397 mentions the use of ultrafine cellulose as an additive for coatings. This cellulose, again, represents very fine cellulose particles having a diameter of 20 nm to 15 μm. The use of the ultrafine cellulose resulted in a matting effect and increased scratch resistance on the part of the coated surfaces.

Furthermore, owing to the insolubility of the cellulose and to differences in density relative to the film former, cellulose-containing paint systems are unstable and tend toward rapid settling. This is particularly true of paint systems having a low viscosity. The separation that occurs when the paint systems are stored makes them more difficult to handle. The sediment which forms after a short time, consisting primarily of cellulose, is extremely compact and is very difficult to redisperse.

There are therefore serious drawbacks to the use of chemically unmodified cellulose as an additive component in paint systems, and there is therefore a need to remedy these drawbacks.

It has surprisingly been found that a paint system which uses chemically unmodified cellulose having a defined average fiber length and a defined average aspect ratio conveys an apparently natural and soft tactility and also exhibits improved scratch resistance on the part of the coating, and, in combination with a polyethylene wax and/or Fischer-Tropsch wax and/or amide wax and/or biobased wax, is subject to an unforeseen stabilization of the paint formulation with respect to sedimentation.

It has been possible, furthermore, by using this combination to achieve, surprisingly, a significant improvement in the scratch resistance.

A subject of the invention is therefore a paint system comprising
a) chemically unmodified cellulose and
b) optionally polyolefin waxes and/or Fischer-Tropsch waxes and/or amide waxes and/or biobased waxes and
c) film formers and
d) optionally solvents or water and
e) optionally pigments, and also
f) optionally volatile and/or nonvolatile additives,
   the chemically unmodified cellulose having an average fiber length between 7 μm and 100 μm, preferably between 15 μm and 100 μm, more preferably between 15 μm and 50 μm, and an average aspect ratio of less than 5.

A further subject of the invention is a method for improving the settling and redispersing behavior and the scratch resistance of paint systems, wherein the paint system is admixed with one or more polyolefin waxes and/or Fischer-Tropsch waxes and/or amide waxes and/or biobased waxes and also with chemically unmodified cellulose which has an average fiber length between 7 μm and 100 μm, preferably between 15 μm and 100 μm, more preferably between 15 μm and 50 μm, and also an average aspect ratio of less than 5. The paint system may further comprise pigments and solvents or water, and also further volatile and/or nonvolatile additives.

Given that it is possible, through the addition of chemically unmodified cellulose having an average fiber length between 7 μm and 100 μm, preferably between 15 μm and 100 μm, more preferably between 15 μm and 50 μm, and an average aspect ratio of less than 5, to achieve an improvement in the scratch resistance and in the tactility of a coating relative to a coating without additions of cellulose, the invention further relates to a method for improving the scratch resistance and for obtaining soft tactility of the coating (fully cured paint system), wherein said paint system is admixed with chemically unmodified cellulose which possesses an average fiber length between 7 μm and 100 μm, preferably between 15 μm and 100 μm, more preferably between 15 μm and 50 μm, and an average aspect ratio of less than 5.

The paint systems may further comprise pigments and solvents and/or water and also further volatile and/or nonvolatile additives.

Pigments, film formers, auxiliaries, and solvents that are contemplated include in principle all suitable materials as are described, for example, in Ullmann's Encyclopedia of Industrial Chemistry, 5^{th} Edition, Vol. A 18, section on Paints & Coatings, Weinheim, 1991, page 368ff or in BASF Handbook, Lackiertechnik, Vincentz-Verlag, 2002, section on Raw Materials, page 28ff.

Binders are understood by analogy to DIN 971-1 to constitute the pigment-free and filler-free fractions of the dried and/or cured coating. As well as the film former, they further include other nonvolatile additives. The coating is understood to be the fully cured and/or dried paint system (cf. BASF Handbook, Lackiertechnik, Vincentz-Verlag, 2002, section on Raw Materials, page 26).

Suitable film formers in accordance with the invention are both polyurethane-based and epoxy-based resins, both in not only 1-component but also 2-component form. Additionally suitable film formers, besides cellulose derivatives, such as cellulose nitrate and cellulose esters, for example, include alkyd resins and also acrylate-based systems, such as polymethyl methacrylate, for example.

Epoxy-based film formers are polyaddition resins which crosslink through at least difunctional epoxide-containing monomers, such as, for example, bisphenol A bisglycidyl ether, diglycidyl hexahydrophthalate, etc., or prepolymers, or macromonomers in conjunction with a further reactant (hardener). They are therefore customarily processed as 2-component resins. Typical hardeners are amines, acid anhydrides, or carboxylic acids. Amines used are frequently aliphatic diamines, such as ethylenediamine, diethylenetriamine, triethylenetetramine, etc., and also cycloaliphatic amines, such as isophoronediamine, etc., or aromatic diamines, such as 1,3-diaminobenzene, etc. Acid anhydrides employed include, for example, phthalic anhydride or diesters of trimellitic anhydride. Epoxy-based film formers of this kind and their application in paints, and also suitable solvent borne, solvent-free, and water-based embodiments are described in Ullmann's Encyclopedia of Industrial Chemistry, 5^{th} Edition, Vol. A 18, Paints & Coatings, section 2.10, Weinheim, 1991, pages 407-412.

Polyurethane-based film formers are likewise polyaddition resins, which are reacted from isocyanate-containing monomers in conjunction with multivalent alcohols. A distinction is made, according to chemical composition of the resin, between 1-component PU paints and 2-component PU paints. Typical isocyanate-containing monomers are based, for example, on toluene diisocyanate (TDI) and diphenylmethane diisocyanate (MDI), polymeric diphenylmethane diisocyanate (PMDI), hexamethylene diisocyanate (HDI), isophorone diisocyanate (IPDI). Polyols are used typically in different complexities as polyester polyols, acrylic acid copolymer, and polyether polyols. PU resins exist as solvent-containing, solvent-free, and also water-based systems. PU resins for paints are described in detail in Ullmann's Encyclopedia of Industrial Chemistry, 5^{th} Edition, Vol. A 18, Paints & Coatings, section 2.9, Weinheim, 1991, pages 403-407.

Polyesters can be divided into saturated and unsaturated polyester binders. Polyester binders are formed from multivalent carboxylic acids such as, for example, terephthalic acid, isophthalic acid, trimellitic acid, adipic acid, sebaccic acid, dimer fatty acids, etc., and from polyols such as, for example, ethylene glycol, diethylene glycol, glycerol, butanediol, hexanediol, trimethylolpropane, etc. Depending on the rigidity of the dicarboxylic acids and of the polyols, the mechanical properties can be varied from soft to hard. Unsaturated polyesters additionally possess polymerizable vinyl groups, which can crosslink through UV light or radical initiators. Polyesters for paints are described in Ullmann's Encyclopedia of Industrial Chemistry, 5^{th} Edition, Vol. A 18, Paints & Coatings, sections 2.6 & 2.7, Weinheim, 1991, pages 395-403.

Alkyd resins belong to the group of the polyesters. They can be divided, according to their drying mechanism, into air-drying and oven-drying systems. In chemical terms, alkyd resins are formed by reaction of polyhydric alcohols, such as glycerol, pentaerythritol, etc., with polybasic acids, such as phthalic acid, phthalic anhydride, terephthalic acid, etc., in the presence of oils and/or unsaturated fatty acids, such as linoleic acid, oleic acid, etc. Alkyd resins are usually admixed with crosslinking-accelerating catalysts, referred to as siccatives. Alkyd resins and their embodiments are described for example in Ullmann's Encyclopedia of Industrial Chemistry, 5^{th} Edition, Vol. A 18, Paints & Coatings, section 2.6, Weinheim, 1991, pages 389-395.

The most important cellulose-based film formers include cellulose nitrate and the cellulose esters, such as cellulose acetate, cellulose acetobutyrates and cellulose propionates, for example. The raw material for such cellulose derivatives is purified native cellulose, which is usually obtained directly from wood. Examples of derivatizing agents are nitrating acid and also the anhydrides of, for example, acetic acid, propionic acid, butyric acid. In contrast to chemically untreated cellulose, cellulose derivatives are soluble in organic solvents, particularly in acetone and ethyl acetate. Cellulose-derivative film formers are described in Ullmann's Encyclopedia of Industrial Chemistry, 5^{th} Edition, Vol. A 18, Paints & Coatings, section 2.2, Weinheim, 1991, pages 369-374.

Industrially, cellulose is of particular interest on account of its very ready availability. Cellulose is the most frequently occurring organic compound in nature, and hence also the most frequent polysaccharide. As a renewable raw material, it constitutes, at about 50 wt %, the principal constituent of plant cell walls. Cellulose is a polymer consisting of the monomer glucose, which is linked via β-1,4-glycosidic bonds and consists of several hundred to ten thousand repeating units. The glucose molecules in the cellulose are each twisted by 180° relative to one another. This gives the polymer a linear form, in contrast, for example, to the glucose polymer starch. The industrial utilization of cellulose as a raw material of the chemical industry extends across a variety of areas of application. Its physical utilization includes its use as a raw material in papermaking and also for the production of clothing. The sources of cellulose that are utilized primarily for these purposes are wood and cotton.

In wood, cellulose is present particularly in the form of fine crystalline microfibrils, which are bundled to form macrofibrils via hydrogen bonds. In conjunction with hemicellulose and lignin, these macrofibrils form the cell wall of the plant cells.

Cellulose is obtained industrially from wood via a variety of cell digestion procedures. In these procedures, lignin and hemicellulose are broken down and dissolved. Among the chemical digestion procedures, distinctions are made between the sulfate process (alkaline) and the sulfite process (acidic). With the sulfite process, for example, wood chips are digested with water and sulfur dioxide (SO₂) under increased pressure and at elevated temperature. In this operation, the lignin is cleaved by sulfonation and so converted to a water-soluble salt, lignosulfonic acid, which is easy to remove from the fibers. Depending on the pH prevailing in the wood, the hemicellulose present is converted by acidic hydrolysis into sugars. The cellulose obtained from this process can then be chemically further modified or derivatized. Alternatively, after washing, the chemically untreated filler can be obtained. Other, less significant digestion procedures are based on mechanical and thermomechanical and also on chemothermo-mechanical digestion procedures.

For the purposes of the invention, the cellulose in these digestion procedures is chemically unmodified. Ullmann's Encyclopedia of Industrial Chemistry, 5^{th} Edition, Vol. A 5, Weinheim 1986, section on Cellulose, page 375ff., contains a more detailed description of cellulose.

Suitable cellulose in the sense of the invention is chemically unmodified cellulose having a particle size as measured by laser diffraction with a D99 of ≦100 μm, preferably ≦50 μm. The D99 figure indicates the maximum particle size present in the particle mixture. Corresponding cellulose powders may also be obtained, optionally, from coarser cellulose material by fractionation, such as screening or sieving, for example, or by micronization. Cellulose is described for instance in Ullmann's Encyclopedia of Industrial Chemistry, 5^{th} Edition, Vol. A 5, Weinheim 1986, section on Cellulose, page 375ff.

The chemically unmodified cellulose is used, based on the paint system, in an amount of 0.1 to 12 wt %, preferably of 0.2 to 6 wt %, more preferably of 1.0 to 2.0 wt %.

Synthetic hydrocarbon waxes, such as polyolefin waxes, for example, are a suitable wax component. These waxes can be produced by thermal degradation of branched or unbranched polyolefin polymers, or by direct polymerization of olefins. Examples of suitable polymerization processes include radical processes, in which the olefins, generally ethylene, are reacted at high pressures and temperatures to form polymer chains with greater or lesser degrees of branching; moreover, processes are contemplated wherein ethylene and/or higher 1-olefins such as, for example, propylene, 1 butene, 1-hexene, etc., are polymerized using organometallic catalysts, examples being Ziegler-Natta or metallocene catalysts, to form unbranched or branched waxes. Corresponding methods of preparing olefin homopolymer and copolymer waxes are described for example in Ullmann's Encyclopedia of Industrial Chemistry, 5^{th} Edition, Vol. A 28, Weinheim 1996 in sections 6.1.1./6.1.2. (high-pressure polymerization, waxes), section 6.1.2. (Ziegler-Natta polymerization, polymerization with metallocene catalysts), and section 6.1.4. (thermal degradation).

It is possible, furthermore, for waxes known as Fischer-Tropsch waxes to be used. These waxes are produced catalytically from synthesis gas, and differ from polyethylene waxes in lower average molar masses, narrower molar mass distributions, and lower melt viscosities.

The hydrocarbon waxes used may be unfunctionalized or functionalized through polar groups. The incorporation of such polar functions may be accomplished subsequently by corresponding modification of the nonpolar waxes, as for example by oxidation with air or by grafting-on of polar olefin monomers, examples being α,β-unsaturated carboxylic acids and/or their derivatives, such as acrylic acid or maleic anhydride. In addition, polar waxes may be produced by copolymerization of ethylene with polar comonomers, examples being vinyl acetate or acrylic acid; additionally by oxidative degradation of nonwaxlike ethylene homopolymers and copolymers of higher molecular mass. Corresponding examples are found for instance in Ullmann's Encyclopedia of Industrial Chemistry, 5^{th} Edition, Vol. A 28, Weinheim 1996, section 6.1.5.

Further suitable polar waxes are amide waxes, as obtainable, for example, by reaction of relatively long-chain carboxylic acids, examples being fatty acids, with mono- or polyfunctional amines. Fatty acids used typically for this purpose have chain lengths in the range between 12 and 24, preferably between 16 and 22, C atoms, and may be saturated or unsaturated. Fatty acids used with preference are the C₁₆ and C₁₈ acids, more particularly palmitic acid and stearic acid, or mixtures of both acids. Suitable amines, besides ammonia, include, in particular, polyfunctional organic amines, examples being difunctional organic amines, in which case ethylenediamine is preferred. Particularly preferred is the use of wax which is standard commercial product under the name EBS wax (ethylenebisstearoyldiamide) and which is produced from industrial stearic acid and ethylenediamine.

It is possible, moreover, to use biobased waxes, which in general are polar ester waxes. Biobased waxes are understood generally to be those waxes which are based on a renewable raw materials basis. They may be both native and chemically modified ester waxes. Typical native biobased waxes are described for example in Ullmann's Encyclopedia of Industrial Chemistry, 5^{th} Edition, Vol. A 28, Weinheim 1996 in section 2. (Waxes). These include, for example, palm waxes such as carnauba wax, grass waxes such as candelilla wax, sugarcane wax, and straw waxes, beeswax, rice wax, etc. Chemically modified waxes usually originate from fatty acids based on vegetable oils, by esterification, transesterification, amidation, hydrogenation, etc. They include, for example, metathesis products of vegetable oils.

The biobased waxes also, furthermore, include montan waxes, either in unmodified or refined and/or derivatized form. Detailed information on such waxes is found for example in Ullmann's Encyclopedia of Industrial Chemistry, 5^{th} Edition, Vol. A 28, Weinheim 1996, Section 3. (Waxes).

There are various suitable methods for incorporating the waxes into the paint system. For example, the wax can be dissolved hot in a solvent, with subsequent cooling giving finely divided, liquid dispersions or compositions of pastelike consistency, which are blended with the paint system. Also possible is the grinding of the waxes in the presence of solvents. According to one widespread technology, the waxes are also stirred as solids, in the form of ultrafinely divided powders (“micronizates”), into the paint formula. The ultrafine powders are produced either by grinding, in air jet mills, for example, or by spraying. The average particle sizes (D50 or median sizes) of such powders are generally in the range between 5 and 15 μm. The D99 for the wax micronizates used is situated at not more than 100 μm, preferably at not more than 60 μm, more preferably at not more than 50 μm. For the possibility of grinding to a micronizate, the hardness or brittleness of the wax products must not be too low.

The waxes are used, based on the paint system, in an amount of 0.1 to 12.0 wt %, preferably of 0.2 to 6.0 wt %, more preferably of 1.0 to 2.0 wt %.

The chemically unmodified cellulose can be incorporated by dispersion either before or after the additization of the paint system with wax; also possible is a joint additization, by incorporation of a mixture of micronized wax and unmodified cellulose. It has proven particularly advantageous to carry out joint micronizing of the unmodified cellulose and the wax and to use them in the form of a micronized mixture. Here as well, the micronized mixture can be incorporated by dispersion before or after the additization of the printing ink system. The methods of dispersion are known to the skilled person; in general this is done using high-speed stirring or mixing elements, examples being Mizer disks or dissolver disks.

In combination with polyolefin waxes and/or Fischer-Tropsch waxes and/or amide waxes and/or biobased wax, a chemically unmodified cellulose in a liquid paint system exhibits a reduced settling tendency; the settled sediment can be more easily redispersed. Furthermore, the set paint exhibits a significant scratch resistance.

The paint systems of the invention may comprise additional volatile and nonvolatile additives such as, for example, plasticizers, crosslinking agents, crosslinking accelerators, UV stabilizers, antioxidants, surfactants, wetting assistants, defoamers, thixotropic assistants, and other assistants in customary additive concentrations.

Paint systems of the invention prove particularly suitable in their use as wood paint, more particularly for the painting of wooden furniture, wooden floors, and wooden articles of any kind. The use of chemically unmodified cellulose with dimensions according to the invention brings about a soft to woodlike and natural feel (tactility), in contrast to an unfilled paint.

The examples below are intended to elucidate the invention in more detail, but without confining the invention to these examples.

### EXAMPLES

### Performance Tests

Raw material used for the inventively chemically unmodified celluloses were Arbocel UFC M 8, Arbocel BE 600-30 PU, and Arbocel BWW 40. Used as a substance for comparison were corn starch particles (manufacturer: Roquette GmbH), which were particle size fractionated by screening. The testing of different particle size distributions, among other factors, was thus possible. The Arbocel products likewise differ in respect of their particle size distributions.

Waxes used were the following commercial products from the range of Clariant Produkte (Deutschland) GmbH:
Ceridust 2051: micronized Fischer-Tropsch wax; D99<50 μm.
Ceridust 3620: micronized polyethylene wax; D99<50 μm.
Ceridust 5551: micronized montan wax; D99<50 μm.

The characteristic particle sizes D50, D90, and D99 were determined according to ISO 13320-1 on the basis of a laser diffraction measurement by means of a Mastersizer 2000 (Malvern). For this purpose the samples were pretreated with a dry dispersing unit (Scirocco 2000).

TABLE 1
Particle size of the waxes/glycosidic polymers used.

| | D50 | D90 | D99 |
|---|---|---|---|
| | [μm] | [μm] | [μm] |
| Native corn starch | 14.2 | 23.2 | 38.8 |
| Screened corn starch | 8.8 | 12.6 | 21.3 |
| Arbocel UFC M 8 | 11.5 | 24.7 | 45.2 |
| Arbocel BE 600-30 PU | 34.0 | 85.6 | 276.0 |
| Arbocel BWW 40 | 64.3 | 210.7 | 593.7 |
| Ceridust 2051 | 7.0 | 12.8 | 21.2 |
| Ceridust 3620 | 8.7 | 15.4 | 24.7 |
| Mixture of micronized | 9.1 | 15.4 | 24.7 |
| polyethylene wax and | | | |
| micronized oxidized | | | |
| polyethylene wax | | | |
| Ceridust 5551 | 8.7 | 14.7 | 24.5 |
| Mixture of micronized | 6.1 | 11.0 | 18.2 |
| polyethylene wax with starch | | | |
| Arbocel UFC M 8/ | 9.4 | 18.7 | 33.5 |
| Ceridust 3620 (50:50), | | | |
| powder mixture | | | |
| Arbocel BE 600-30/ | 15.2 | 62.2 | 176.2 |
| Ceridust 3620 (50:50), | | | |
| powder mixture | | | |

### Determination of Scratch Resistance

For the determination of the scratch resistance, the paint system under test was applied to a glass surface and tested using a hardness testing rod from Erichsen (TYPE 318). The scratch resistance was determined in a method based on DIN ISO 1518, using the hardness testing rod and a Bosch engraver having a diameter of 0.75 mm. The scratch track ought to be about 10 mm in length and leave a distinct mark behind in the paint. By adjustment of the spring tension, different forces can be exerted on the paint surface. The force which is required in order to leave behind a distinct mark in the paint was measured for a wide variety of paint formulations.

### Assessment of Tactility

The tactility of the individual paint surfaces was assessed by rubbing with the back of the hand. Furthermore, the assessment was carried out by 20 individuals, in order to obtain independent opinions. The assessment in the tables corresponds to the opinion of the majority.

### Determination of Coefficient of Sliding Friction

The coefficient of sliding friction was determined using a model 225-1 friction peel tester from Thwing-Albert Instruments Company in a method based on that of ASTM D2534. For this purpose, a glass plate coated with the paint under test was applied to the analysis instrument. A leather-covered metal carriage (349 g) was then placed onto the coated surface. The carriage was then drawn over the coated glass surface, at constant speed (15 cm/min). A measurement was made of the force needed in order to pull the carriage. Since it was the dynamic coefficient of sliding friction that was ascertained, it was possible to disregard the initial force needed in order to start the carriage moving.

### Testing of Settling and Redispersing Behavior

In a measuring cylinder, 4 g of each of the samples under investigation were dispersed in 200 g of a 2-component solvent-containing polyurethane paint (2 K PUR) and in 200 g of butyl acetate; the dispersion was left to stand. The layer thickness of the settled sediment was read off after specified time intervals. The smaller the figure found, the denser the sediment and the higher the settling tendency. The redispersibility of the sediment was tested by carefully swirling the measuring cylinder. The results are set out in table 2.

TABLE 2
Settling and redispersing behavior

| | | Sediment thickness | | | |
|---|---|---|---|---|---|
| | | read off [cm] | | | Redispersibility |
| Ex- | | after | after | after | after |
| ample | | 1 h | 24 h | 1 week | 1 week |
| 1 | Native corn | 0.9 | 1.1 | 1.1 | Sediment compact, |
| (comp.) | starch in | | | | multiple tipping |
| | 2 K PUR | | | | needed for |
| | | | | | redispersing |
| 2 | Arbocel | 0.3 | 1.9 | 1.9 | Sediment compact, |
| (inv.) | BE600-30 PU | | | | multiple tipping |
| | in 2 KPUR | | | | needed for |
| | | | | | redispersing |
| 3 | Arbocel | No | 2.2 | 2.2 | Sediment cloudy to |
| (inv.) | BE600-30 PU/ | sedi- | | | suspended; single |
| | Ceridust 3620 | ment | | | tipping sufficient |
| | (50:50), pow- | visible | | | for redispersing |
| | der mixture | | | | |
| | in 2 K PUR | | | | |
| 4 | Native corn | 0.8 | 1.0 | 1.0 | Sediment compact, |
| (comp.) | starch in | | | | multiple tipping |
| | butyl acetate | | | | needed for |
| | | | | | redispersing |
| 5 | Arbocel | 2.4 | 2.4 | 2.4 | Sediment cloudy to |
| (inv.) | BE600-30 PU | | | | suspended; single |
| | in butyl acetate | | | | tipping sufficient |
| | | | | | for redispersing |
| 6 | Arbocel | 3.6 | 3.5 | 3.5 | Sediment cloudy to |
| (inv.) | BE600-30 PU/ | | | | suspended; single |
| | Ceridust 3620 | | | | tipping sufficient |
| | (50:50), pow- | | | | for redispersing |
| | der mixture | | | | |
| | in butyl | | | | |
| | acetate | | | | |

As shown by table 2, the greater the thickness of the sediment, the more effectively the particles can be redispersed. In both systems, native corn starch forms a compact sediment which is difficult to redisperse. In both systems, the powder mixtures of native cellulose Arbocel BE600-30 PU and polyethylene wax showed a significantly reduced settling tendency and the best redispersibilities. The native cellulose Arbocel BE600-30 PU on its own likewise showed an improved settling tendency. In the 2 K PUR paint, redispersibility was difficult to accomplish, but easily possible in butyl acetate.

### Testing in a 2-Component Solvent-Based Polyurethane Paint:

A PUR paint with the following composition was used:

Formula:
1^{st} component

| | |
|---|---|
| Desmophen 1300/75% in xylene | 32.0 wt % |
| Walsroder nitrocellulose E 510 in 20% ESO | 1.5 wt % |
| Acronal 4 L 10% in ethyl acetate | 0.2 wt % |
| Baysilone OL 17 10% in xylene | 0.2 wt % |
| Ethyl acetate | 10.4 wt % |
| Butyl acetate | 11.0 wt % |
| Methoxypropyl acetate | 10.8 wt % |
| Xylene | 8.9 wt % |
| | 75.0 wt % |

2^{nd} component

| | |
|---|---|
| Desmodur IL | 14.2 wt % |
| Desmodur L 75 | 9.4 wt % |
| Xylene | 1.4 wt % |
| | 25.0 wt % |

The paint system described is admixed with 2% or 4% of micronizate (wax or cellulose or wax/cellulose mixture) and applied with a doctor blade (60 μm) to a glass surface. After a drying time of 24 hours, and also after subsequent 24-hour storage in a conditioning chamber, the scratch resistance and the coefficient of sliding friction can be determined. The values are illustrated in table 3.

TABLE 3
Tactility, sliding friction, and scratch
resistance of the paint systems tested.

| | | | Coef- | Scratch |
|---|---|---|---|---|
| | | | ficient | resis- |
| Ex- | | | of sliding | tance |
| ample | Additive | Tactility | friction | [N] |
| 7 | no wax | unnatural | 0.83 | 0.1 |
| (comp.) | | | | |
| 8 | 2% Ceridust 5551 | very soft/soft | 0.58 | 0.5 |
| (comp.) | | | | |
| 9 | 4% Ceridust 5551 | very soft/soft | 0.52 | 0.9 |
| (comp.) | | | | |
| 10 | 2% Ceridust 3715 | soft | 0.38 | 0.3 |
| (comp.) | | | | |
| 11 | 4% Ceridust 3715 | soft | 0.34 | 0.4 |
| (comp.) | | | | |
| 12 | 2% Ceridust 3620 | soft | 0.52 | 0.8 |
| (comp.) | | | | |
| 13 | 4% Ceridust 3620 | soft | 0.44 | 0.9 |
| (comp.) | | | | |
| 14 | 2% Ceridust 2051 | soft | 0.39 | 0.7 |
| (comp.) | | | | |
| 15 | 4% Ceridust 2051 | soft | 0.45 | 0.9 |
| (comp.) | | | | |
| 16 | 2% Arbocel UFC M8 | very soft/soft | 0.56 | 1.0 |
| (inv.) | 50% + Ceridust 3620 | | | |
| | 50% | | | |
| 17 | 4% Arbocel UFC M8 | very soft/soft | 0.52 | 1.1 |
| (inv.) | 50% + Ceridust 3620 | | | |
| | 50% | | | |
| 18 | 2% Arbocel BE600-30PU | natural wood | 0.69 | 1.0 |
| (inv.) | 50% + Ceridust 3620 | tactility | | |
| | 50% | | | |
| 19 | 4% Arbocel BE600-30PU | natural wood | 0.70 | 1.2 |
| (inv.) | 50% + Ceridust 3620 | tactility | | |
| | 50% | | | |
| 20 | 2% corn starch + PE wax | soft | 0.67 | 0.8 |
| (comp.) | 50/50, jointly micronized | | | |
| 21 | 4% corn starch + PE wax | soft | 0.66 | 0.8 |
| (comp.) | 50/50, jointly micronized | | | |
| 22 | 2% corn starch Roquette | soft | 0.63 | 0.8 |
| (comp.) | fine | | | |
| 23 | 4% corn starch Roquette | soft | 0.60 | 0.6 |
| (comp.) | fine | | | |
| 24 | 2% corn starch Roquette | soft | 0.73 | 0.7 |
| (comp.) | normal | | | |
| 25 | 4% corn starch Roquette | soft | 0.78 | 0.6 |
| (comp.) | normal | | | |
| 26 | 2% Arbocel UFC M8 | very soft/soft | 0.68 | 0.6 |
| (inv.) | | | | |
| 27 | 4% Arbocel UFC M8 | very soft/soft | 0.59 | 0.8 |
| (inv.) | | | | |
| 28 | 2% Arbocel BE600-30 | natural wood | 0.75 | 0.8 |
| (inv.) | PU | tactility | | |
| 29 | 4% Arbocel BE600-30 | natural wood | 0.76 | 1.1 |
| (inv.) | PU | tactility | | |
| 30 | 2% Arbocel BWW40 | rough | 0.81 | 0.6 |
| (comp.) | | | | |
| 31 | 4% Arbocel BWW40 | rough | — | 0.8 |
| (comp.) | | | | |

At 0.1 N, the scratch resistance of the above-described polyurethane paint (Example 3) has a very low value. By adding the Arbocel products Arbocel UFC M8 and Arbocel BE 600-30 PU (Examples 22-25) it was possible to achieve a significant increase in the scratch resistance. Specifically, the addition of Arbocel BE 600-30 PU (Examples 24 and 25) raises the scratch resistance of the paint used to a particularly high degree. Through the use of wax/cellulose mixtures (Examples 12-15), the scratch resistance of the paint system is increased still further.

The addition of chemically unmodified cellulose with a defined fiber length and also a defined aspect ratio to the paint system described has a positive effect on its tactility. The paint systems described in Examples 22 and 23, both containing Arbocel UFC M8 as an additive component, are notable for a particularly soft-feeling tactility. The addition of Arbocel BE 600-30, in contrast, produced a woodlike and natural feel.

If the paint system described is admixed with a combination of cellulose and wax (Examples 12-15), the tactility of the resulting paint corresponds to that of the corresponding cellulose-containing paint. Moreover, through the combination of cellulose and wax, the scratch resistance is improved significantly in the manner described above, thereby producing, especially in Examples 14 and 15, a natural woodlike tactility in combination with a greatly increased scratch resistance.

Arbocel BWW 40 was not tested in combination with wax, since it could not be applied without problems because of the size of the cellulose particles. Nor was it possible to measure a figure for the scratch resistance when using 4 percent Arbocel BWW 40 (Example 27), since the paint surface was very inhomogeneous.

The addition of a micronized wax to the paint system described achieves the desired increase in scratch resistance through a reduction in the coefficient of sliding friction (Examples 8-15). This is unwanted, in the case of the coating of floors, for example.

The addition of chemically unmodified cellulose to the paint system described leads to an increase in the scratch resistance of the paint in conjunction with only a slight lowering of the coefficient of sliding friction (Examples 26-29). This positive effect is also achieved when using chemically unmodified cellulose in combination with a micronized wax (Examples 16-19).

### Testing in a Water-Based Polyurethane Paint:

A PUR paint with the following composition was used:

Formula

| | |
|---|---|
| Bayhydrol UH 2342 | 89.0 wt % |
| Demineralized water | 3.0 wt % |
| Dipropylene glycol dimethyl ether | 3.0 wt % |
| BYK 028 | 0.8 wt % |
| BYK 347 | 0.5 wt % |
| Schwego Pur 6750, 5% in water | 1.5 wt % |
| | 100.0 wt % |

This paint system too was admixed with 2% or 4% of micronizate and applied with a doctor blade (60 μm) to a glass surface. After a drying time of 24 hours and subsequent 24-hour storage in a conditioning chamber, it was possible to determine the scratch resistance and the coefficient of sliding friction. The values are illustrated in table 4.

TABLE 4

| | | | Coef- | Scratch |
|---|---|---|---|---|
| | | | ficient | resis- |
| Ex- | | | of sliding | tance |
| ample | Additive | Tactility | friction | [N] |
| 32 | no wax | unnatural | 0.57 | 0.1 |
| (comp.) | | | | |
| 33 | 2% Ceridust 5551 | very soft/soft | 0.59 | 0.5 |
| (comp.) | | | | |
| 34 | 4% Ceridust 5551 | very soft/soft | 0.51 | 0.7 |
| (comp.) | | | | |
| 35 | 2% Ceridust 3715 | soft | 0.52 | 0.5 |
| (comp.) | | | | |
| 36 | 4% Ceridust 3715 | soft | 0.46 | 0.6 |
| (comp.) | | | | |
| 37 | 2% Ceridust 3620 | soft | 0.51 | 0.5 |
| (comp.) | | | | |
| 38 | 4% Ceridust 3620 | soft | 0.46 | 0.5 |
| (comp.) | | | | |
| 39 | 2% Ceridust 2051 | soft | 0.47 | 0.6 |
| (comp.) | | | | |
| 40 | 4% Ceridust 2051 | soft | 0.43 | 0.7 |
| (comp.) | | | | |
| 41 | 2% Arbocel UFC M8 | very soft/soft | 0.63 | 0.8 |
| (inv.) | 50% + Ceridust | | | |
| | 3620 50% | | | |
| 42 | 4% Arbocel UFC M8 | very soft/soft | 0.55 | 0.9 |
| (inv.) | 50% + Ceridust | | | |
| | 3620 50% | | | |
| 43 | 2% Arbocel BE600-30PU | natural wood | 0.70 | 1.1 |
| (inv.) | 50% + Ceridust 3620 | tactility | | |
| | 50% | | | |
| 44 | 4% Arbocel BE600-30PU | natural wood | 0.69 | 1.2 |
| (inv.) | 50% + Ceridust 3620 | tactility | | |
| | 50% | | | |
| 45 | 2% corn starch + PE wax | soft | 0.54 | 0.4 |
| (comp.) | 50/50 jointly micronized | | | |
| 46 | 4% corn starch + PE wax | soft | 0.48 | 0.5 |
| (comp.) | 50/50 jointly micronized | | | |
| 47 | 2% corn starch Roquette | soft | 0.66 | 0.3 |
| (comp.) | fine | | | |
| 48 | 4% corn starch Roquette | soft | 0.64 | 0.4 |
| (comp.) | fine | | | |
| 49 | 2% corn starch Roquette | soft | 0.71 | 0.3 |
| (comp.) | normal | | | |
| 50 | 4% corn starch Roquette | soft | 0.70 | 0.4 |
| (comp.) | normal | | | |
| 51 | 2% Arbocel UFC M8 | very soft/soft | 0.59 | 0.6 |
| (inv.) | | | | |
| 52 | 4% Arbocel UFC M8 | very soft/soft | 0.59 | 0.9 |
| (inv.) | | | | |
| 53 | 2% Arbocel BE600-30 | natural wood | 0.73 | 0.8 |
| (inv.) | PU | tactility | | |
| 54 | 4% Arbocel BE600-30 | natural wood | 0.74 | 1.1 |
| (inv.) | PU | tactility | | |
| 55 | 2% Arbocel BWW40 | rough | 0.76 | 0.6 |
| (comp.) | | | | |
| 56 | 4% Arbocel BWW40 | rough | — | 0.8 |
| (comp.) | | | | |

Through the addition of Arbocel UFC M8 and Arbocel BE 600-30 PU (Examples 47-50) to the paint system described, an increase was achievable in the scratch resistance. The tactility of the resulting paint system varies with the size of the cellulose micronizate used. The somewhat coarser Arbocel BE 600-30 PU variant imparts a natural wood tactility. The combination of Arbocel with a wax gave the best results in terms of scratch resistance. The tactility of the paints to which mixtures of cellulose micronizate and wax micronizate were added was comparable with that of those modified solely by the addition of Arbocel products. Through the combination of a wax micronizate and a cellulose micronizate it is possible to realize a natural wood tactility with the paint system described, in conjunction with an increased scratch resistance.

In this system as well, Arbocel BWW 40 was not tested in combination with wax, since again it caused application problems because of the size of the cellulose particles. In analogy to the solvent-based system, no scratch resistance value could be measured at a concentration of 4 percent Arbocel BWW 40 (Example 52), since the paint surface was very inhomogeneous.

The addition of chemically unmodified cellulose to the paint system described results in an increase in the scratch resistance of the paint, with only a slight lowering of the coefficient of sliding friction (Examples 51-54). This positive effect is also achieved when using chemically unmodified cellulose in combination with a micronized wax (Examples 41-44).

### Testing in a Water-Based Acrylic Paint:

An acrylic paint with the following composition was used:

Formula
Part 1:

| | | |
|---|---|---|
| i) | Viacryl VSC 6295w/45WA | 88.5 wt % |
| ii) | Butyl glycol | 3.8 wt % |
| iii) | Ethyl diglycol | 2.0 wt % |
| iv) | Demineralized water | 4.0 wt % |

Part 2:

| | | |
|---|---|---|
| i) | Coatex BR 100 (thickener) | 0.4 wt % |
| ii) | Surfynol DF 110 | 0.5 wt % |
| iii) | BYK 348 | 0.2 wt % |

Part 3:

| | | |
|---|---|---|
| i) | BYK 347 | 0.2 wt % |
| ii) | BYK 380 N | 0.4 wt % |
| | | 100.0 wt % |

### Production:

Part 1 was stirred in a dissolver at about 1500 rpm for about 10 minutes. Then the components from part 2 were added individually in succession, and dispersion took place at about 2000 rpm for 10 minutes. The 3^{rd} part was added to the dissolver at about 1000 rpm. Lastly the waxes, celluloses, or starches (2% and 4%) were incorporated at 1500 rpm, with a stirring time of 20 minutes.

Following its preparation, this paint was likewise applied with a doctor blade (60 μm) to a glass surface. After a drying time of 24 hours and subsequent 24-hour storage in a conditioning chamber, it was possible to determine the scratch resistance and the coefficient of sliding friction.

1. A paint system comprising
a) chemically unmodified cellulose and
b) optionally polyolefin waxes and/or Fischer-Tropsch waxes and/or amide waxes and/or biobased waxes and
c) film formers and
d) optionally solvents or water and
e) optionally pigments, and also
f) optionally volatile and/or nonvolatile additives,
the chemically unmodified cellulose having an average fiber length between 7 μm and 100 μm and an average aspect ratio of less than 5.

2. The paint system as claimed in claim 1, wherein the chemically unmodified cellulose is used in an amount, based on the paint system, of 0.1 to 12.0 wt %.

3. The paint system as claimed in claim 1, wherein the waxes are used in an amount, based on the paint system, of 0.1 to 12.0 wt %.

4. The paint system as claimed in claim 1, wherein the polyolefin waxes or Fischer-Tropsch waxes or amide waxes or biobased waxes are used in micronized form with a D99 of not more than 100 μm.

5. The paint system as claimed in claim 1, wherein a film former is selected from the group consisting of the epoxy resins (1- or 2-component), the polyurethanes (1- or 2-component), the acrylate resins, and the cellulose derivatives.

6. A method for improving the tactility and the scratch resistance of paint systems, wherein the system is admixed with chemically unmodified cellulose which possesses an average fiber length between 7 μm and 100 μm and also an average aspect ratio of ≦5.

7. A method for improving the settling and redispersing behavior and also the tactility and the scratch resistance of paint system, wherein the system is admixed with polyolefin waxes and/or Fischer-Tropsch waxes and/or amide waxes and/or biobased waxes and also with chemically unmodified cellulose which possesses an average fiber length between 7 μm and 100 μm and also an average aspect ratio of ≦5.

8. The method as claimed in claim 6, wherein the chemically unmodified cellulose is used in an amount, based on the paint system, of 0.1 to 12.0 wt %.

9. The method as claimed in claim 7 wherein the waxes are used in an amount, based on the paint system, of 0.1 to 12.0 wt %.

10. The patent system as claimed in claim 1, wherein the paint system of the invention is used with customary additives such as crosslinking agents The paint system as claimed in claims 1 3 claim 1, wherein a film former is used from one of the groups selected from the group of the epoxy resins (1 or 2-component), the polyurethanes (1 or 2-component), the acrylate resins, and the cellulose derivatives, more particularly cellulose nitrate and cellulose esters, or the group of the alkyd resins, crosslinking accelerators, flow control assistants, wetting assistants, defoamers, plasticizers, pigments, UV stabilizers, antioxidants, and other auxiliaries.

11. The paint system as claimed in claim 1, wherein a film former is cellulose nitrate and cellulose esters.
